(19) United States
(12) Patent Application Publication
(10) Pub. No.: US 2006/0173697 A1
(43) Pub. Date: Aug. 3, 2006

(54) Method and system for value added international mail service

(76) Inventor: George M. Brookner, Norwalk, CT (US)

Correspondence Address: PERMAN & GREEN, 425 POST ROAD, FAIRFIELD, CT, 06824, US

(21) Appl. No.: 11/047,545

(22) Filed: Jan. 31, 2005

(51) Int. Cl. G06Q 99/00

(52) U.S. Cl. 705/1

(57) ABSTRACT

A method for providing mailing services between countries includes applying a tracking number to a mailing, encoding actual sender and recipient information of the mailing being sent from one country to another, and monitoring postal tracking to the destination using the tracking number.

### BACKGROUND

The disclosed embodiments are related to providing mailing services between countries while keeping the identity of the mailing sender and mailing recipient from becoming common knowledge.

### BRIEF DESCRIPTION OF RELATED DEVELOPMENTS

Countries have either privatized or maintain their own government or semi-government mailing services. A large amount of mail moves between countries on a daily basis. Mail from a postal service provider being transported from one country to another generally needs to go through a transfer from origination country to the receiving country and from the receiving country to the mail piece destination. During this transfer, the actual sender and recipient may be recorded by the various carriers who may in turn attempt to provide services directly to the actual sender or recipient to the detriment of the original postal service provider.

### SUMMARY OF THE EXEMPLARY EMBODIMENTS

The actual sender and recipient of mail being sent by a postal service provider from one country to another are encoded to prevent recording or otherwise becoming common knowledge. An international mail service transaction broker provided by the postal service provider monitors postal tracking to the destination with the ability to decode the encoded data on or related to an international mailing, and the encoding provides the identities of the originator and recipient. The Posts involved with the Post-to-Post transfer may only identify the related mailings by an identification number.

The international mail service transaction broker may directly inform either or both the sender and recipient of the progress of the mailing in transit

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention.

### DETAILED DESCRIPTION OF THE EXEMPLARY EMBODIMENTS

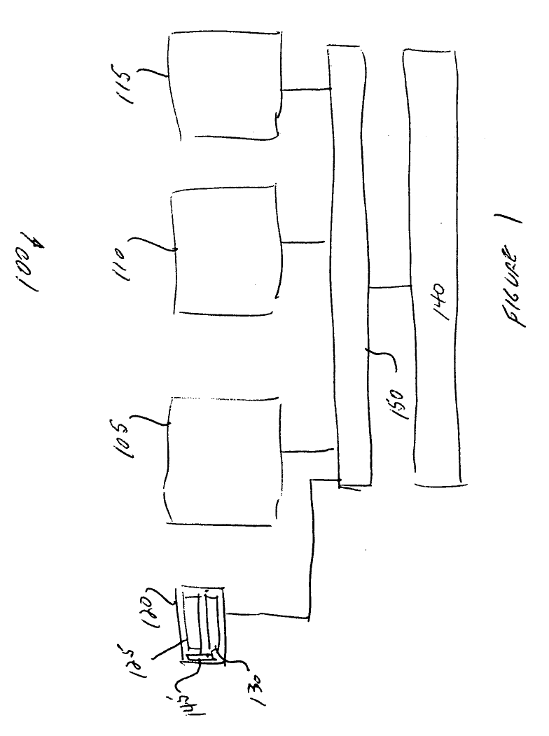

FIG. 1 shows a block diagram of a system 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

It is a feature of the disclosed embodiments to provide for a secure method for keeping the identity of the mailing sender and mailing recipient from becoming common knowledge within the mail transporting from one country to another and any intermediate stations in between.

It is another feature of the disclosed embodiments to provide for coding the mailing (either on the mailing or associated with the mailing) so that the mailing, the sender, the recipient, or any combination thereof is not decipherable by a post or mail handler while the mailing is in transit from sender to recipient.

It is yet another feature of the disclosed embodiments to associate the identity protection of the sender and recipient to an independent international mail service transaction broker. The broker may have the ability to monitor and track available Post mailing-in-transit information from the normal mailing identification number related to the value-added tracking service requested by the mailing sender. For example, in the U.S. the USPS CONFIRM services provide this type of mailing identification.

It is yet another feature of the disclosed embodiments to have the international mail service transaction broker inform either of, or both the sender and recipient the progress of the mailing in transit.

It is still another feature of the disclosed embodiments to provide the international mail service transaction broker with credentials, typified by Public Key Cryptography, to guarantee that only the associated public key holders may either encrypt and or prove the mail transit information provided is from the international mail service transaction broker.

Referring to FIG. 1, a mail piece 120 having sender 125 and recipient 130 information may be deposited into the mail stream of a postal service provider 140. A tracking number 145 is applied and the sender 125 and recipient 130 information is encoded to prevent recording. As the mail piece moves from region to region 105, 110, 115, for example different countries, a transaction broker provides tracking services based on the tracking number.

As mentioned, the actual sender and recipient of mail being sent by a postal service provider from one country to another are encoded to prevent recording or otherwise becoming common knowledge. An international mail service transaction broker employed by the postal service provider monitors postal tracking to the destination with the ability to decode the encoded data on or related to an international mailing, and the encoding provides the identities of the originator and recipient. The Posts involved with the Post-to-Post transfer may only identify the related mailings by an identification number. The international mail service transaction broker may directly inform either or both the sender and recipient of the progress of the mailing in transit

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for providing mailing services between countries comprising:
applying a tracking number to a mailing;
encoding actual sender and recipient information of the mailing being sent from one country to another; and
monitoring postal tracking to the destination using the tracking number.

2. The method of claim 1 further comprising associating the identity protection of the sender and recipient to an independent international mail service transaction broker.

3. The method of claim 2 further comprising providing the independent international mail service transaction broker with credentials pertaining to the encoding of the actual sender and recipient information.

4. The method of claim 1 further comprising informing the sender and/or the recipient of the progress of the mailing in transit.

5. The method of claim 1, wherein the mailing is identified by an identification number during a post to post transfer of the mailing.

6. A system for providing mailing services between countries comprising:
a means for applying a tracking number to a mailing;
a means for encoding actual sender and recipient information of the mailing being sent from one country to another; and
a means for monitoring postal tracking to the destination using the tracking number.

7. The system of claim 6 further comprising a means for associating the identity protection of the sender and recipient to an independent international mail service transaction broker.

8. The system of claim 7 further comprising a means for providing the independent international mail service transaction broker with credentials pertaining to the encoding of the actual sender and recipient information.

9. The system of claim 8 wherein the credentials are typified by public key cryptography.

10. The system of claim 6 further comprising a means for informing the sender and/or the recipient of the progress of the mailing in transit.

11. The system of claim 6, wherein the mailing is identified by an identification number during a post to post transfer of the mailing.
